(19) United States
(12) Patent Application Publication
(10) Pub. No.: US 2020/0118726 A1
(43) Pub. Date: Apr. 16, 2020

(54) REACTOR AND MANUFACTURING METHOD THEREOF

(71) Applicant: TOYOTA JIDOSHA KABUSHIKI KAISHA, Toyota-shi (JP)

(72) Inventor: Shingo MIYAMOTO, Toyota-shi (JP)

(73) Assignee: TOYOTA JIDOSHA KABUSHIKI KAISHA, Toyota-shi (JP)

(21) Appl. No.: 16/560,314

(22) Filed: Sep. 4, 2019

(30) Foreign Application Priority Data
Oct. 10, 2018 (JP) 2018-191988

(51) Int. Cl. H01F 27/02; H01F 41/00

(52) U.S. Cl. CPC H01F 27/022; H01F 27/306; H01F 41/005

(57) ABSTRACT

A reactor may include: a ring core having a ring shape; a resin cover covering the ring core with a space left on an inner side relative to the ring core; and a columnar core around which a winding is wound. The columnar core may be fixed to the resin cover in a state where each of ends of the columnar core is opposed to an inner surface of the ring core.

### CROSS-REFERENCE TO RELATED APPLICATION

This application claims priority to Japanese Patent Application No. 2018-191988 filed on Oct. 10, 2018, the contents of which are hereby incorporated by reference into the present application.

### TECHNICAL FIELD

The teaching disclosed herein relates to a reactor in which a winding is wound around a core and a manufacturing method of the reactor. Especially, the teaching disclosed herein relates to a reactor in which a column-shaped core (a columnar core) is placed on an inner side of a ring-shaped core (a ring core) and a winding is wound around the columnar core.

### BACKGROUND

Japanese Patent Application Publication No. 2009-141111 (Patent Literature 1) describes a reactor in which a column-shaped core (a columnar core) is placed on an inner side of a ring-shaped core (a ring core). A winding is wound on the columnar core. Each end of the columnar core is opposed to an inner surface of the ring core. Recesses are provided at two locations on the inner surface of the ring core, and each end of the columnar core fits in corresponding one of the recesses. In Patent Literature 1, the ring core and the columnar core are respectively termed an “O-type core” and an “I-type core”.

### SUMMARY

In the reactor of Patent Literature 1, the recesses are provided on the inner surface of the ring core, thus a shape of the ring core is complicated. Due to this, cost for the ring core increases. The disclosure herein provides a technique that reduces cost of a reactor including a ring core and a columnar core.

A reactor disclosed herein may comprise a ring-shaped core (ring core), a resin cover, and a columnar core around which a winding is wound. The resin cover may cover the ring core with a space left at a center of the ring core. In other words, the resin cover also has a ring shape, and the space is ensured at its center. The columnar core may be fixed to the resin cover in a state where each of ends of the columnar core is opposed to an inner surface of the ring core. In the reactor disclosed herein, the columnar core is fixed to the resin cover on an inner side relative to the ring core. There is no need to provide a recess on the inner surface of the ring core, and the reactor can be obtained at low cost.

A gap between the resin cover and the winding may be filled with a potting material. The disclosure herein also provides a manufacturing method suitable for such a reactor. This manufacturing method may comprise: fixing the columnar core around which the winding is wound to the resin cover covering the ring core; and filling the gap between the resin cover and the winding with the potting material.

Details and further improvements to the techniques disclosed herein will be described in the following DETAILED DESCRIPTION.

### BRIEF DESCRIPTION OF DRAWINGS

FIG. 1 is a perspective view of a reactor of an embodiment.

FIG. 2 is a perspective view of the reactor of the embodiment (with a winding depicted with a virtual line).

FIG. 3 is a cross-sectional view of the reactor along a line III-III in FIG. 1.

FIG. 4 is a cross-sectional view of the reactor along a line IV-IV in FIG. 1.

FIG. 5 is a perspective view of a ring core.

FIG. 6 is a perspective view of a resin cover.

FIG. 7 is a diagram for explaining a method of manufacturing the reactor.

### DETAILED DESCRIPTION

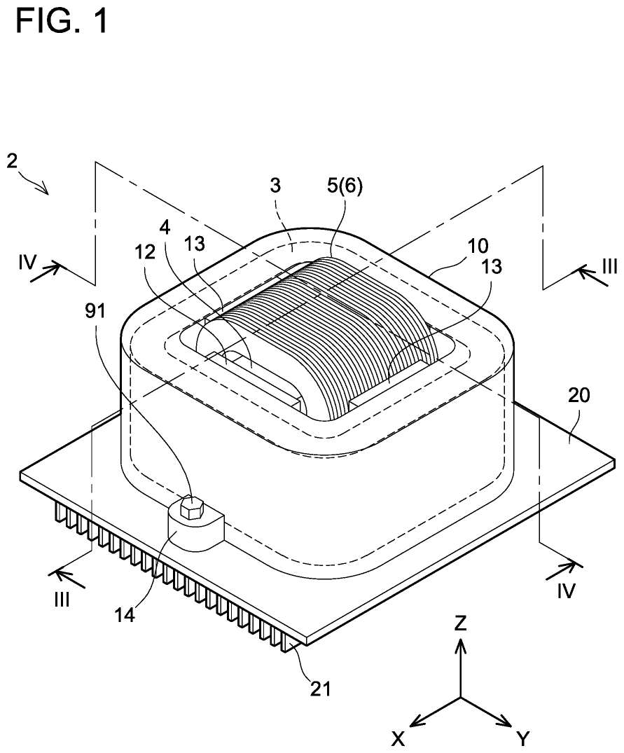

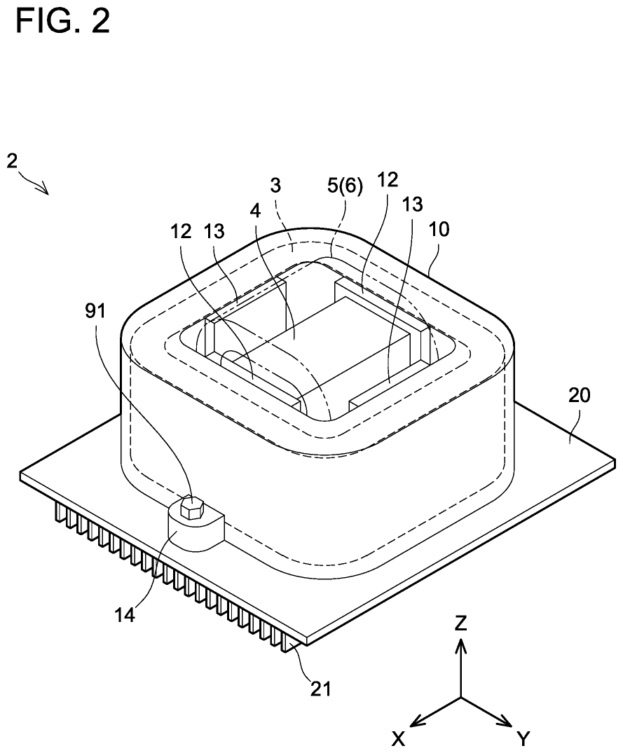

A reactor 2 of an embodiment will be described with reference to the drawings. FIG. 1 shows a perspective view of the reactor 2. The reactor 2 is provided with a ring core 3, a resin cover 10 covering the ring core 3, a columnar core 4 around which a winding 5 is wound, and a cooler 20. The wound winding 5 configures a coil 6. The winding 5 is a rectangular wire. The coil 6 is configured by winding the rectangular winding 5 edgewise. In FIG. 1 (and in all the subsequent drawings), lead wires of the coil 6 (both ends of the winding 5) are omitted from the drawings. To aid further understanding, the reactor 2 with the winding 5 (coil 6) depicted by a virtual line is shown in FIG. 2. An X direction in a coordinate system in the drawings corresponds to an axial direction of the columnar core 4. For the convenience of explanation, a +Z direction in the coordinate system in the drawings is defined as “upward”.

The ring core 3 has a quadrangular ring shape with rounded corners. The ring core 3 includes four flat outer surfaces and four flat inner surfaces. The resin cover 10 covers the ring core 3 such that a center of the ring core 3 has a space. In other words, the resin cover 10 also has a quadrangular ring shape, and the space is ensured at its center.

The columnar core 4 around which the winding 5 is wound is placed in the space provided on an inner side relative to the resin cover 10 covering the ring core 3. The columnar core 4 is fixed to the resin cover 10 in a state where each of its ends is opposed to corresponding one of the inner surfaces of the ring core 3. A pair of positioning guides 12 is provided on a pair of inner surfaces of the resin cover 10, respectively. Each of the positioning guides 12 is a protrusion that protrudes from its corresponding inner surface of the resin cover 10. The positioning guides 12 are provided respectively at two locations on the inner surfaces of the resin cover 10 so as to be opposed to each other. The columnar core 4 is fitted between the pair of positioning guides 12. A distance between the pair of positioning guides 12 is slightly shorter than a length of the columnar core 4. The columnar core 4 is press-fitted between the pair of positioning guides 12 to be fixed therebetween.

When current flows in the winding 5, a magnetic field is generated in the columnar core 4. Magnetic flux of the magnetic field enters the ring core 3 from one of the ends of the columnar core 4. The magnetic flux passes through the ring core 3 and returns to the columnar core 4 from the other end of the columnar core 4. A gap is present between each end of the columnar core 4 and its corresponding inner surface of the ring core 3. These gaps are filled with resin of the resin cover 10. The gaps are provided to suppress magnetic saturation. Characteristics of the magnetic saturation in the reactor 2 may be adjusted by thicknesses of the positioning guides 12 (thicknesses thereof in the X direction in the coordinate system of the drawings).

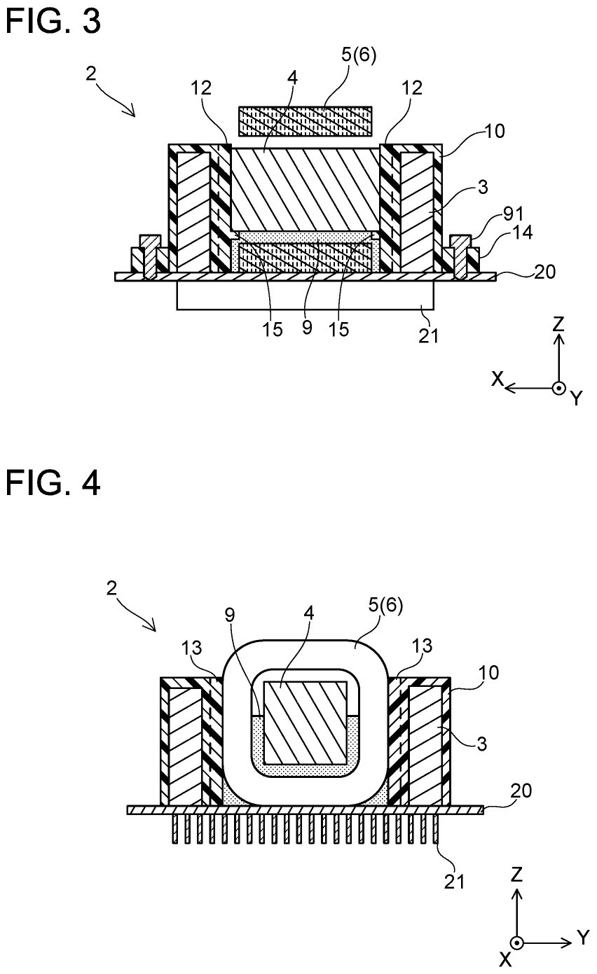

FIG. 3 shows a cross-sectional view of the reactor 2 along a line III-III in FIG. 1. As described above, the columnar core 4 is press-fitted between the pair of positioning guides 12 and is engaged therebetween. Each of the positioning guides 12 is provided with a stopper 15 that abuts a side surface of the columnar core 4. The side surface of the columnar core 4 refers to a surface thereof parallel to the axial direction (X direction in the drawings). The stoppers 15 are protrusions that protrude from the positioning guides 12. A position of the columnar core 4 in the Z direction in the coordinate system of the drawings is determined by the side surface of the columnar core 4 abutting the stoppers 15.

A space between the resin cover 10 and the winding 5 is filled with a potting material 9. The potting material 9 is a filler that is originally in a liquid state and cures by ultraviolet rays, air, or heat. The potting material 9 used in the reactor 2 may, for example, be a filler containing silicon. By the filling with the potting material 9, vibration resistance of the columnar core 4 is improved and heat from the columnar core 4 and the coil 6 is efficiently transmitted to the cooler 20.

The cooler 20 is fixed with bolts 91 via fixing portions 14 provided on the resin cover 10. The fixing portions 14 are protrusions provided on an outer side relative to the resin cover 10. Through holes are provided in the fixing portions 14, and the bolts 91 inserted to the through holes are fixed to the cooler 20.

FIG. 4 shows a cross-sectional view of the reactor 2 along a line IV-IV in FIG. 1. As shown in FIGS. 2 and 4, a pair of protrusions 13 which positions the coil 6 is provided respectively on a pair of inner surfaces of the resin cover 10. The protrusions 13 are provided respectively on the inner surfaces of the resin cover 10 so as to be opposed to each other. The resin cover 10 includes four flat inner surfaces, the positioning guides 12 are provided respectively on two flat surfaces that are parallel to each other, and the protrusions 13 are provided respectively on the other two flat surfaces that are parallel to each other. In other words, the pair of positioning guides 12 is provided to be arranged along the coil axial direction (X direction), and the pair of protrusions 13 is provided to be arranged along a direction intersecting the coil axial direction (Y direction). The winding 5 is wound in a quadrangular tube shape, and the coil 6 thereby has a quadrangular tube shape. The coil 6 is placed on the inner side relative to the resin cover 10 in a state where a pair of parallel side surfaces of the coil 6 is interposed between the pair of protrusions 13 (see FIG. 4). A gap between the winding 5 (coil 6) and the columnar core 4 is also filled with the potting material 9. The potting material 9 fills the gap up to about a half the height of the columnar core 4 in a vertical direction (Z direction in the drawings). The potting material 9 may completely fill the gap between the coil 6 and the columnar core 4.

As shown in FIGS. 3 and 4, surfaces of the ring core 3 and the coil 6 opposed to the cooler 20 are exposed, and they directly contact the cooler 20. Due to this direct contact, heat from the ring core 3 and the coil 6 is efficiently absorbed by the cooler 20.

A plurality of fins 21 is provided on a lower surface of the cooler 20. Although not shown, the lower surface of the cooler 20 faces a coolant passage. The heat from the ring core 3 and the coil 6 (as well as the columnar core 4) is efficiently absorbed by a coolant via the fins 21.

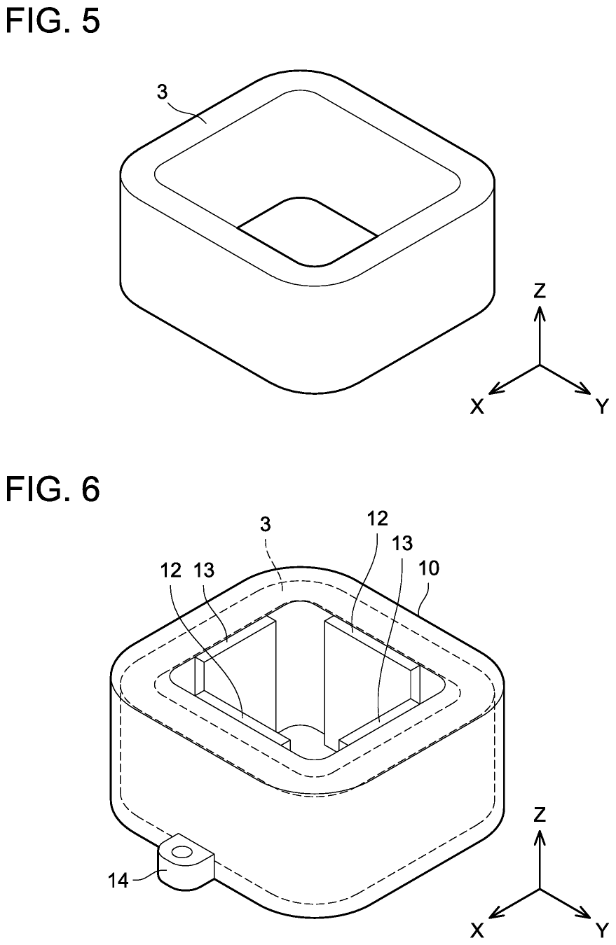

FIG. 5 shows a perspective view of the ring core 3. The ring core 3 has the quadrangular ring shape with rounded corners. The ring core 3 has no recesses nor protrusions on its surfaces and has a simple shape. Due to this simple shape, the ring core 3 can be obtained at low cost.

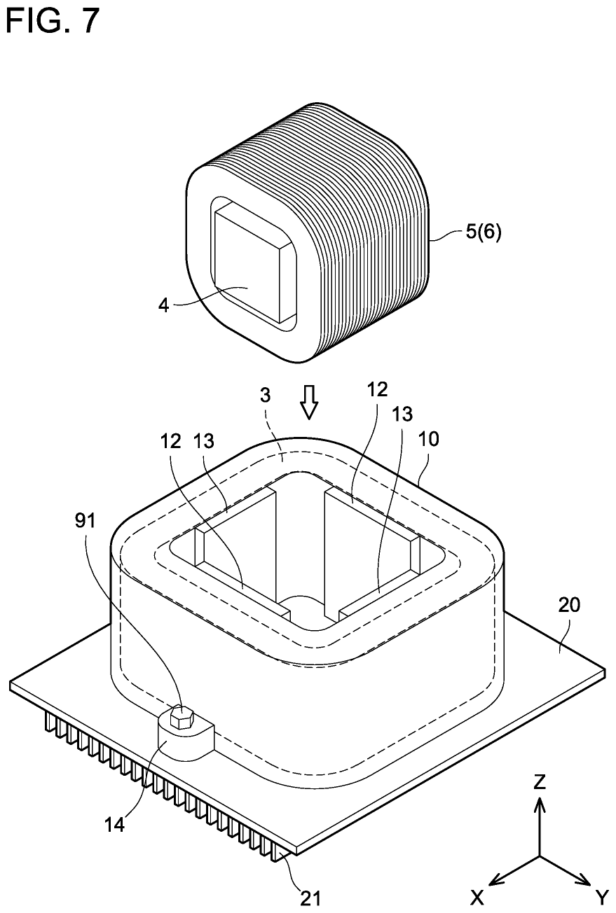

FIG. 6 shows a perspective view of the resin cover 10 covering the ring core 3. The resin cover 10 has the quadrangular ring shape with its center provided with a space, similar to the ring core 3. The pair of positioning guides 12 and the pair of protrusions 13 are provided on the inner surfaces of the resin cover 10. Since the resin cover 10 is fabricated in an injection molding step, the positioning guides 12 and the protrusions 13 are fabricated simultaneously with a body of the resin cover 10 in the injection molding step. As such, the resin cover 10 provided with the positioning guides 12 and the protrusions 13 can be obtained at lower cost as compared to providing positioning guides and protrusions on the ring core 3.

A method of manufacturing the reactor 2 will be described. Independent from preparation of the resin cover 10 in FIG. 6, the winding 5 is wound on the columnar core 4. Next, the columnar core 4 around which the winding 5 is wound is fixed to the resin cover 10 covering the ring core 3 (fixing step, see FIG. 7). In doing so, the columnar core 4 is press-fitted between the pair of positioning guides 12 and the coil 6 (winding 5) is press-fitted between the pair of protrusions 13. As a result, the columnar core 4 around which the winding 5 is wound is fixed to the resin cover 10 on the inner side relative to the ring thereof.

After the columnar core 4 is fixed to the resin cover 10, the potting material 9 fills in the gap between the resin cover 10 and the coil 6 (winding 5) and the gap between the coil 6 and the columnar core 4 (filling step, see FIGS. 3 and 4). Further, the cooler 20 is attached to the resin cover 10 with the bolts 91 (FIG. 7). According to the above, the reactor 2 is completed.

Some features related to the technique described in the embodiment will be described. Each of the ring core 3 and the resin cover 10 has the quadrangular ring shape with rounded corners. Each of the ring core 3 and the resin cover 10 may have a circular or elliptic shape.

As an example of a structure for fixing the columnar core, a positioning guide that contacts one of the ends of the columnar core may be provided on the resin cover. The positioning guide is fabricated simultaneously with the body of the resin cover in the injection molding step. The resin cover including the positioning guide can be obtained at low cost. An example of the positioning guide is a protrusion protruding from the inner surface of the ring of the resin cover.

A fixing portion which fixes the cooler may be provided on the resin cover. The fixing portion can also be fabricated simultaneously with the body of the resin cover in the injection molding step. The resin cover including the positioning guide and the fixing portion can also be obtained at low cost.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A reactor comprising:
a ring core having a ring shape;
a resin cover covering the ring core with a space left on an inner side of the ring core; and
a columnar core around which a winding is wound,
wherein
the columnar core is fixed to the resin cover in a state where each of ends of the columnar core is opposed to an inner surface of the ring core.

2. The reactor of claim 1, wherein the resin cover comprises a positioning guide that contacts with one of the ends of the columnar core.

3. The reactor of claim 2, wherein the positioning guide is a protrusion protruding from an inner surface of the resin cover.

4. The reactor of claim 1, wherein the resin cover comprises a fixing portion which fixes a cooler.

5. The reactor of claim 1, wherein a gap between the resin cover and the winding is filled with a potting material.

6. A manufacturing method of the reactor according to claim 5, the method comprising:
fixing the columnar core around which the winding is wound to the resin cover covering the ring core; and
filling the gap between the resin cover and the winding with the potting material.
